(19) United States
(12) Patent Application Publication
(10) Pub. No.: US 2026/0085910 A1
(43) Pub. Date: Mar. 26, 2026

(54) Cognitive Firearms Training System With Multisensory Stimuli

(71) Applicant: REACCT Systems, LLC, San Antonio, TX (US)

(72) Inventors: Thomas James Branyon, San Antonio, TX (US); David Moody, San Antonio, TX (US)

(21) Appl. No.: 19/337,682

(22) Filed: Sep. 23, 2025

Related U.S. Application Data
(60) Provisional application No. 63/698,033, filed on Sep. 23, 2024.

(51) Int. Cl. F41G 3/26; F41J 5/04; F41J 5/14; G09B 9/00

(52) U.S. Cl. CPC F41G 3/2655; F41J 5/04; F41J 5/14; G09B 9/003

(57) ABSTRACT

A dry-fire training system and method that uses multiple types of cues (e.g., visual and audible stimuli) presented to the trainee within a predetermined time, preferably simultaneously. The system includes a control application that communicates with one or more targets, each target having light emitting devices capable of displaying different colors and light sensors. The application commands the targets to display different colors to the trainee, along with playing different sounds. One combination of visual stimuli (e.g., a specific color, like “red”) and audible stimuli (e.g., a specific sound, like a “car horn” or “bell”) is a “trigger condition.” Based on whether the trainee, using either a traditional firearm equipped with a laser-emitting cartridge or a simulated firearm that only emits a laser, “shoots” the target, the system determines with the result is a “valid shoot,” a “miss,” or a “bad shoot.”

### CROSS REFERENCES TO RELATED APPLICATIONS

This application claims priority to and the benefit of U.S. provisional application no. 63/698,033, filed Sept. 23, 2024, which is incorporated by reference.

### FEDERALLY SPONSORED RESEARCH OR DEVELOPMENT Not applicable.

### BACKGROUND OF THE INVENTION

### 1. Field of the Invention

The present invention relates to firearm training. More specification, the invention relates to dry-fire training using multiple types of cues presented to the trainee within a predetermined time and, preferably, simultaneously.

### 2. Background of the Related Art

The proper and safe use of a firearm depends on developing a number of important cognitive and mechanical skills. It is well established that dry-fire training, that is, practicing aiming a firearm and pulling the trigger without live ammunition, can be an effective and cost-efficient method for improving and retaining marksmanship skills. Current cost-effective dry-fire systems utilizing lasers for feedback primarily focus on mechanical marksmanship, particularly accuracy and raw speed. For both law enforcement personnel as well as responsible civilian firearm owners, the legal and ethical use of a firearm in a defensive scenario requires a great deal of ability to acquire multiple visual and audible cues and make a decision as to whether or not the present scenario justifies the use of deadly force, before proceeding to draw and discharge their firearm, all in a very brief period of time. Current cost-effective dry-fire training systems merely focus on the mechanical-marksmanship aspect of firearms handling, or provide only limited cues that must be processed before firing, such as a shot timer. More complex systems may exist which involve displays, virtual reality goggles, or similar, but these tend to drive the cost of the system well beyond what is desirable or accessible to an average firearms owner in today's economy.

### SUMMARY OF THE INVENTION

The present invention is a system that provides the user with a method to perform firearms training which requires the use of cognitive processing and decision-making abilities. The system involves presenting the user with multiple cues and requiring him to discern whether the cues match a predefined pattern or condition before drawing and dry firing his firearm. In this document, “firearm” generally refers to a traditional firearm equipped with a laser-emitting cartridge, or a simulated firearm which only emits a laser. The system is composed of a control application, run from a user's mobile device or PC, and a target device which includes light sources of multiple colors, a hit sensing feature, and a wireless communication interface.

The present system is advantageous over existing solutions in that it forces the user to process multiple streams of information from multiple points in space and make a decision before deciding to draw and fire his firearm. Other systems include waiting for a shot-timer beep, or a single light color to turn on, but these can be anticipated and do not force the user to decide whether the stimulus is valid or not. Some systems place the target or targets all directly in front of the user, which does not force the user to remain aware of his surroundings in multiple directions as in a real-life scenario. The system presents the user with one of several audible sounds from the app and one of several colors (on each target device, of which there may be more than one present) at random, and the user must determine whether or not they match a predetermined combination and- only in the case of a match-proceed to draw and dry fire their firearm on the target which has displayed the trigger color. Because multiple target devices can be used, and the target devices are self-contained—that is, they do not require use of a mobile-phone camera to detect hits, but can detect hits autonomously—the targets can be placed at widely different locations relative to the user, forcing him to be aware of potential targets outside of his field of vision in any one direction. The system provides a simple and relatively low-cost platform for frequent home training without live ammunition, and particularly for training cognitive processing capabilities for defensive shooting scenarios.

### BRIEF DESCRIPTION OF THE DRAWINGS

FIG. 1A depicts an embodiment of the system in a symbolic representation.

FIG. 1B depicts the embodiment in a functional block diagram representation

FIG. 2 shows an exploded view of a target device of the embodiment.

FIG. 3 shows the operation of the embodiment in flowchart form for startup and a single drill.

FIG. 4 shows an example of the control application display of the embodiment.

FIG. 5 shows simplified schematic view of the target device circuitry.

FIG. 6 details the visual delineation between the active target area and the LED emission area.

### DETAILED DESCRIPTION OF CERTAIN EMBODIMENTS

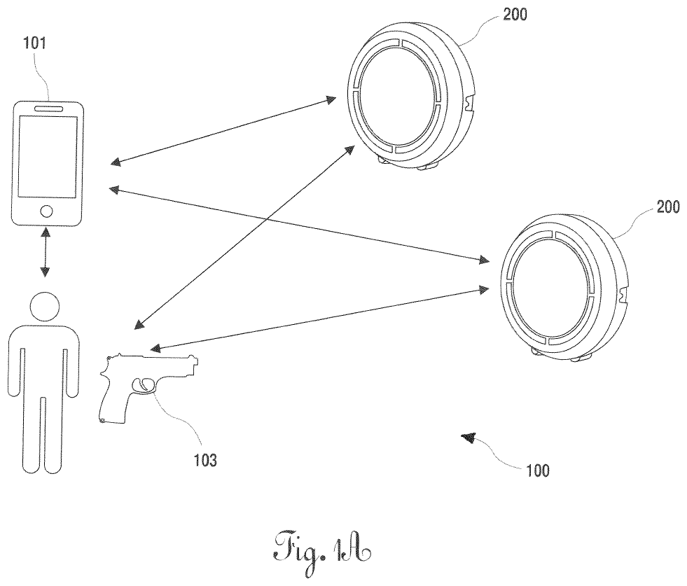

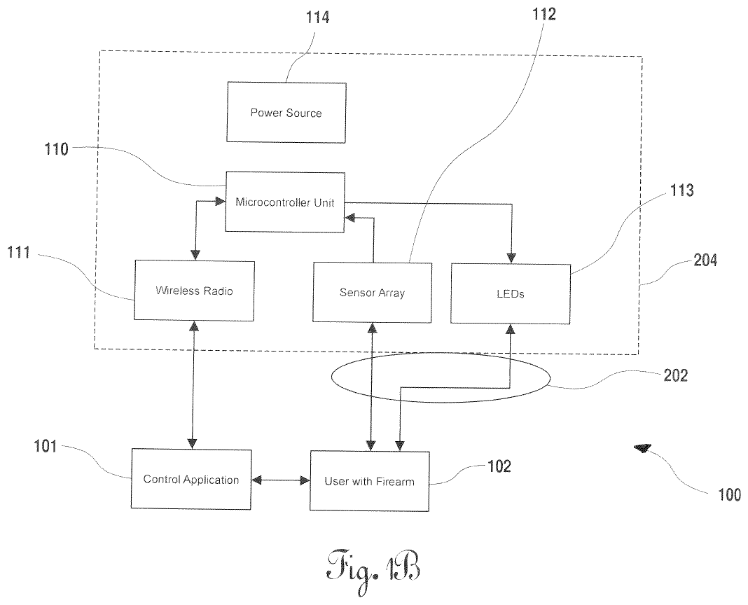

FIG. 1A-1B shows an embodiment 100 of the system, which includes a target device 200 (of which there may be more than one in any given system) connected wirelessly to a control application 101 run on a user's mobile device. The system is operated by the user 102, who is equipped with a laser-emitting firearm 103 (either a traditional firearm with a laser cartridge, or a simulated firearm which emits a laser upon a trigger pull), via the control application 101 (the “app”).

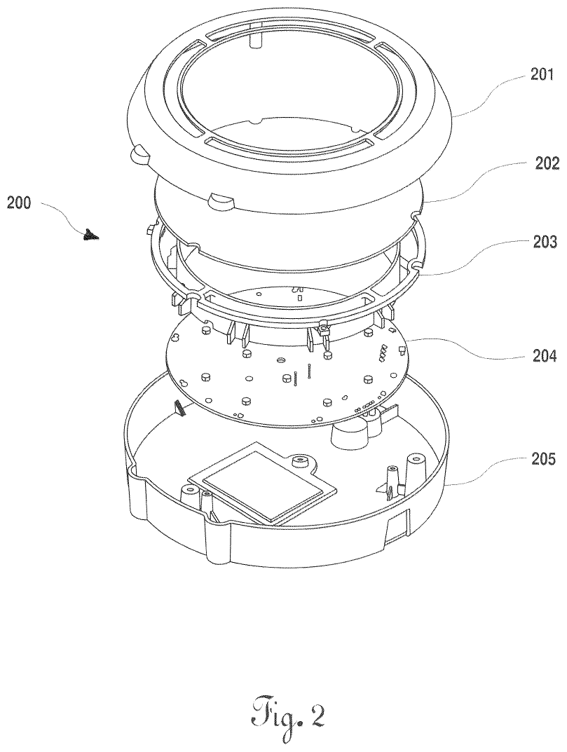

FIG. 2 shows an exploded view of a target device 200 of the embodiment. The device 200 has a printed circuit board assembly 204 contained in a plastic housing having a top housing 201 and bottom housing 205. The device 200 includes a rigid light-diffusing element 202 in front of the circuit board, which in this embodiment is an acrylic sheet.

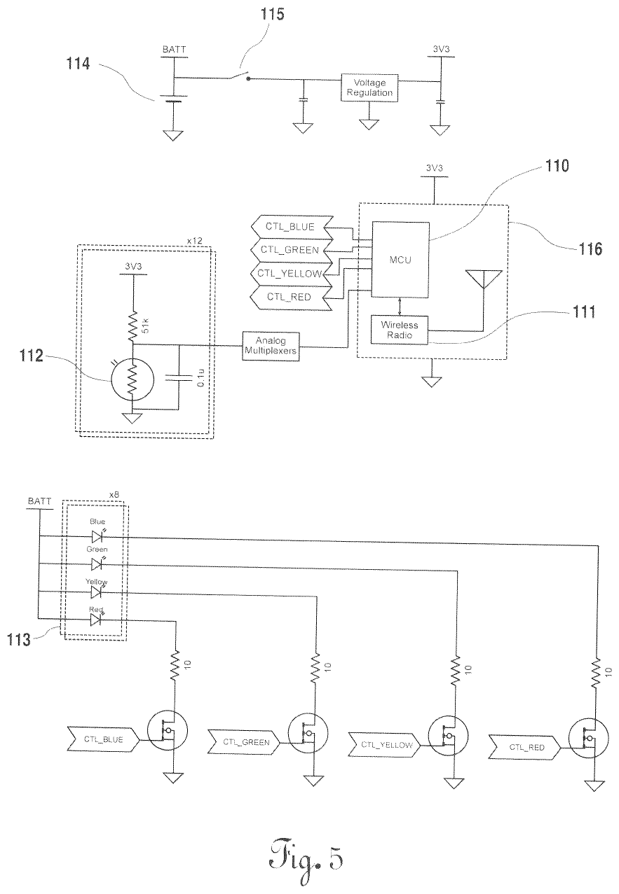

FIG. 5 shows a schematic representation of the circuit board 204. It contains a microcontroller unit (MCU) 110 that controls an array of various colors of LEDs 113 and processes signals from an array of light sensors 112, a Bluetooth Low Energy (BLE) radio module 111 for exchanging commands and information with the control application, a battery holder 114 for providing power, and a power switch 115. The MCU 110 and wireless radio 111 may be one combined module on the circuit board. The light-diffusing element 202, such as an acrylic polycarbonate, translucent silicone, or frosted glass sheet, serves not only to protect the circuit board 204 from mechanical and electronic damage while in use, but also diffuses incident light from the laser beam emitted from the user's firearm 103, which in turn allows for the use of substantially fewer light sensors on the circuit board 204, and thus lowers the cost and complexity of the device 200 for a given target size relative to saturating the circuit board with light sensors. The diffuser element 202 may also have a sheet of filter material applied to the area directly above the sensor array 112 to increase diffusion and absorb wavelengths of light which are not of interest to the system, such as a red vinyl sheet which absorbs the blue and green content of ambient light while allowing the red light of the laser emitter to pass through to the sensors 112. The LEDs 113 are placed at the edge of the circuit board 204 so as to be outside of the active target area and not interfere with the light levels received by the sensors 112. The housing contains a clamp and light shield component 203 which fixes the diffuser element 202 to the top housing 201 and blocks the emitted LED light from reaching the sensors 112.

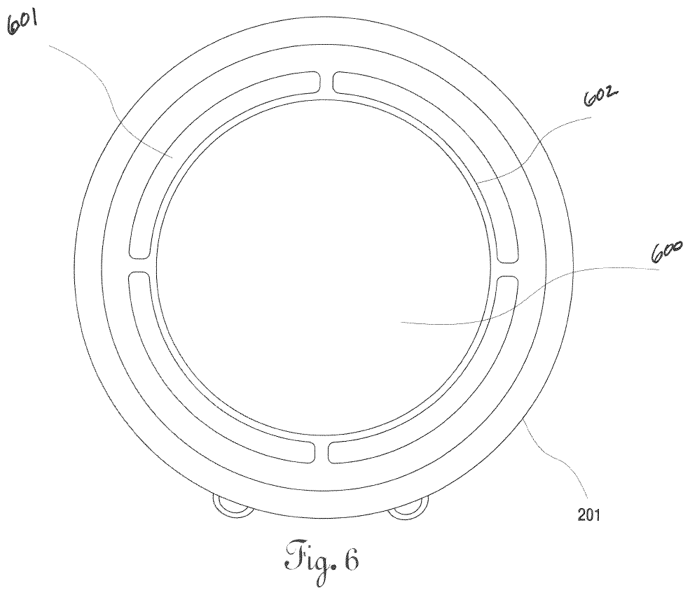

As shown in FIG. 6, the top housing 201 features a thin ring 602 which differentiates the active target area 600 from the outer region 601 from which the LED light emanates. An active target area diameter of approximately 5.7″ provides a reasonable tradeoff between device cost and suitability for representing an ideal hit area in a defensive shooting scenario, but other sizes are possible. The top housing 201 and bottom housing 205 contain features for conveniently locating the device, such as an integral stand, stabilizing surfaces, and/or wall hanging cavities or hooks. The housing also contains a removable battery cover for facilitating easy replacement of batteries.

The app 101 provides the controls for interacting with the target(s) 200. The app 101 is used to scan for and connect to targets 200. Once connected, the app 101 can control targets 200 during drills, read back information from them, and provide status information such as battery level, signal strength, serial number, firmware information, and any fault conditions. The app 101 provides a means for the user 102 to select the trigger color and sound for a drill, and plays sounds and commands target colors during a drill. The app 101 receives relevant information from target(s) 200 during/after drill cycles and displays them to the user. The app 101 also provides means for viewing performance data from past drills. The app 101 may also provide scores based on the user's 102 performance and/or leaderboards allowing the user 102 to compare their performance to others.

### Operation

Operation of the system centers around a “drill,” which is a sequence which terminates in the user firing upon a target 200, or failing to fire upon a valid target 200 within a predefined length of time. Before a drill is executed, one or more targets 200 are placed at distances and angles from the user that are either prescribed by the app 101 for a certain scenario, or chosen by the user according to their preferences and training goals. For maximum situational awareness training, the user could place two targets 200 180° apart from each other with respect to themselves, or use other creative placements that challenge their ability to acquire and process the stimuli.

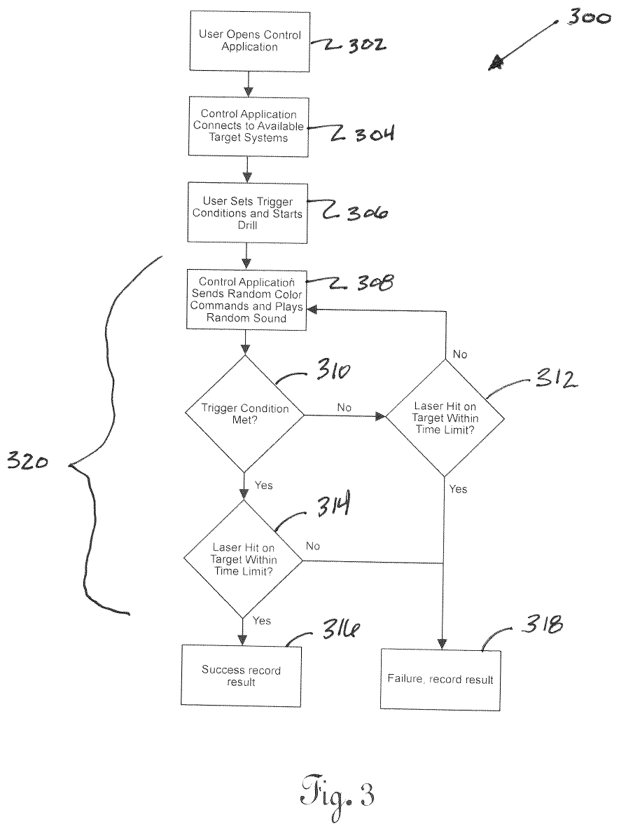

FIG. 3 shows an embodiment 300 of a process of starting and running a single drill 320. The user begins ideally with a holstered firearm 103. After opening the app (step 302), the control application communicatively connects to available targets (step 304). The app 101 is then used to set the trigger condition(s) and begin the drill (step 306).

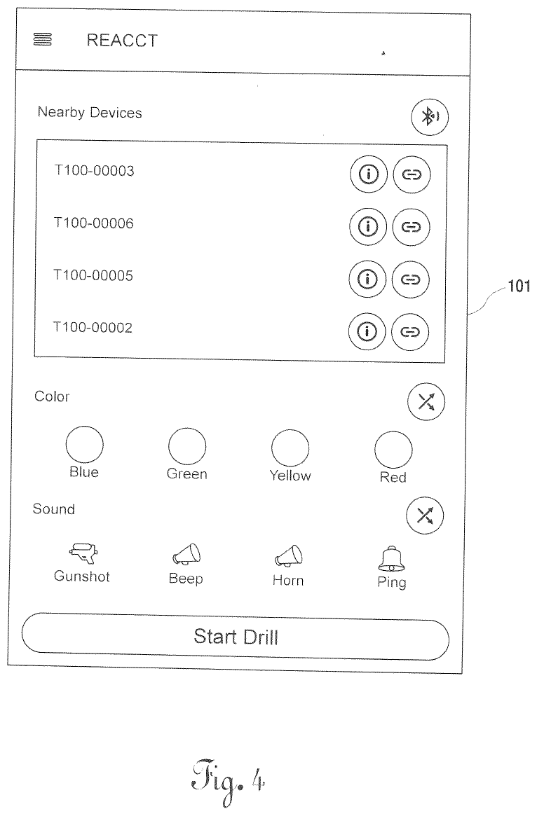

FIG. 4 shows a display with which user can identify nearby targets, select the trigger sound and color which must be present to create a valid shoot condition (the “trigger condition”), and start a drill. The user presses a soft button (“Start Drill”) to begin the drill 320.

Referring again to FIG. 3, the app 101 then cycles through combinations of sounds played and colors displayed on each target 200 at random, with various delays between cycles, until a trigger condition is produced. This is achieved by playing sounds through the app 101 and/or associated hardware (i.e. mobile phone speakers, Bluetooth earbuds, etc.) and the app 101 wirelessly sending color commands to the connected target(s). The target(s) 200, upon receiving the command, illuminate the corresponding color LEDs 113. When a trigger condition occurs, the user has a certain timeout period within which he must fire on the active target area of the target 200 displaying the trigger color (steps 310, 314). Otherwise the drill is scored as a “miss” or “timeout. ” Light sensors 112 on the target 200 detect the laser hit and transmit information about the hit (such as elapsed time from trigger to hit, hit location, etc.) to the app 101. If at any time a target 200 is hit when the trigger condition is not matched, the drill is marked as a “bad shoot” (or similar verbiage) (Steps 312, 318). At the end of the drill, the user can see his result, and then holster his weapon or otherwise prepare anew and start the drill again.

Aggregated data, such as elapsed time and/or hit locations/accuracy, can be analyzed statistically along with the user's consistency over time in training to provide various scores that inform the user of their current proficiency as well as trends over time. Such scoring could also be used by law enforcement agencies for new trainees or veteran personnel to monitor their training habits and encourage consistency in training. Finally, scores could be used to compile leaderboards for the population of users to add a competitive dimension to the experience, making the use of the system more engaging and increasing compliance in training regimens.

### Alternative Embodiments

The general form described above is not exhaustive as to the form and features that this invention may take on. There are several alternative embodiments that could exist, including but not limited to the following:

The target device could utilize a camera module for detecting hits instead of light sensors.

A sensor module could be attached to the user's firearm and holster to detect exact draw times and detect if the firearm is drawn under an invalid condition.

This system could be adapted to live fire training by attaching inertial or audio sensors to a steel plate target with a protected strip of LEDs placed near or around the edge of the target.

A drill could involve multiple hits, either on the same target or proceeding to additional targets in a “chase the color”type of scenario.

Those skilled in the art will recognize that wireless communication between the app and the targets is the most convenient however this does not mean a wired connection is not possible instead.

The app could be implemented on several hardware devices, including but not limited to a mobile phone, tablet, laptop/PC, single-board computer, or dedicated hardware.

The targets could make use of another battery size or chemistry, such as 18650 Li-ion cells or similar.

The targets could be powered by an AC/DC adapter instead of an internal power source.

The targets could use an alternative wireless protocol, such as WiFi or LoRa (especially for outdoor live fire use).

The targets could be hardwired to the device on which the control application resides.

While the drill preferably presents a trigger condition, in alternative embodiments it does not present a trigger condition.

While the drill preferably has a single trigger condition (e.g., “red” and “gunshot”), the drill may have multiple trigger conditions (e.g., “red” and “gunshot” as well and “blue” and “horn”).

While the drill preferably randomly selects random visual and audible stimuli for presentation to the trainee, the drill may alternatively use predetermined combinations of such stimuli in a predetermined order.

1. A method for cognitive firearms training comprising:
providing one or more target devices, each comprising light-emitting elements capable of displaying a plurality of colors;
providing a control application capable of playing a plurality of audible sounds and controlling the light-emitting elements on the one or more target devices;
randomly generating and presenting combinations of audible sounds and visual stimuli through the light-emitting elements on the one or more target devices;
establishing a predefined trigger condition comprising a specific combination of one of the audible sounds and one of the colors of the light-emitting elements;
requiring a user to determine whether the combination of the audible sound and visual stimulus presented matches the predefined trigger condition;
requiring the user to draw and dry fire a firearm only when the trigger condition is met; and
providing feedback on the user's performance based on whether the user correctly identifies the trigger condition and fires upon a target device displaying the appropriate visual stimulus within a predetermined time period and the elapsed time between the presentation of the trigger condition and the user's firing action.

2. The method of claim 1, further comprising evaluating the accuracy of the hit location on the target device displaying the trigger color, wherein additional feedback is provided on the user's marksmanship performance based on the hit location relative to a center of the target device's target area.

3. The method of claim 1, further comprising detecting, using a holster draw sensor, when the user draws the firearm from a holster, wherein additional feedback is provided based on whether the firearm is drawn under valid or invalid trigger conditions and the time interval taken to draw under valid trigger conditions.

4. A firearm training system comprising:
a control application stored in a computer-readable medium of a mobile device or computer, the control application comprising computer-executable instructions to:
command one or more targets to display a color selected from a plurality of colors;
command the mobile device, or hardware in communication with the mobile device, to play a sound selected from a plurality of sounds;
start a first timer upon issuing one or both of the command to display a color or the command to play a sound;
receive data from the control application indicating the detection of light by a plurality of light sensors;
determining whether an indication of the detection of light by a target displaying
determine if a trigger condition has been met, wherein the trigger condition is a combination of at least a sound and a color presented within a predetermined time of one another;
a target in communication with the control application, the target comprising:
a microcontroller connected to or having a computer-readable medium;
a plurality of light emitting diodes (LEDs) controllable by the microcontroller, the plurality of LEDs having at least two colors;
the plurality of light sensors, which are connected to the microcontroller;
a set of software instructions stored in the computer-readable medium of the target to:
determine when the plurality of light sensors has provided a signal to the microcontroller indicating the detection of light;
transmit data to the control application indicating the detection of light by the plurality of light sensors;
upon receiving a command from the control application to display a color, controlling the plurality of LEDs to display that color;

5. The firearm training system of claim 4 wherein the predetermined time is no more than 5 seconds.

6. The firearm training system of claim 5 wherein the predetermined time is no more than one-half second.

7. A method for firearms training, the method comprising the steps of:
displaying a first color on a target having light sensors;
playing a sound within a first predetermined time before or after displaying the first color;
starting a timer within a second predetermined time before or after (1) displaying the color, (2) playing the sound, or (3) both displaying the color and playing the sound;
determining whether the target has detected light before expiration of the timer;
determining whether the displayed color and played sound satisfy a trigger condition.

8. The method of claim 7 further comprising the step of displaying a second color on a second target having light sensors, wherein the second color is different from the first color.
